(19) United States
(12) Patent Application Publication
(10) Pub. No.: US 2003/0088431 A1
(43) Pub. Date: May 8, 2003

(54) Automatic price correcting system

(76) Inventors: Yoshinobu Hara, Tokyo (JP); Takanobu Inomoto, Tokyo (JP); Jiyunji Uchida, Tokyo (JP); Hiroshi Takahashi, Tokyo (JP)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/031,459

(22) PCT Filed: Jun. 6, 2001
(86) PCT No.: PCT/JP01/04770

(30) Foreign Application Priority Data
Jun. 7, 2000 (JP) 2000-170479

(51) Int. Cl. G06F 17/60

(52) U.S. Cl. 705/1; 705/400; 705/20; 705/26

(57) ABSTRACT

An automatic price correcting system in which the seller and the buyer communicate with each other via network, is provided. The system comprises a standard price storing section for storing a price presented by the seller in response to specifications of an article presented by the buyer, as a standard price, a standard specifications table for storing specifications presented by the buyer and a correction table for storing information required to correct the standard price of the article, presented by the seller. According to the system, difference between the specifications of the article stored in the standard specifications table and changed specifications of the article, is converted into a correction value of price, trough means of referring to the correction table, when the specifications of the article are changed. The standard price stored in the standard price storing section is corrected using the correction value of price. Since the system allows a quick and simple estimation on a price in response to changes in the specification, efficiency of changing specifications is improved.

### TECHNICAL FIELD

The present invention relates to a system for automatically correcting a price the seller has presented responding to specifications presented by the buyer, according to changes in the specifications caused by the buyer.

### BACKGROUND ART

Nowadays systems for acquiring articles (for example, parts and commodities) have been established. These acquiring systems generally employ auction style. That is, a buyer company acquiring articles makes the specifications of the articles open to the public through the Internet. According to the specifications of the articles, respective trading partners (sellers) present their bidding prices. If a plurality of trading partners actually present their prices, the trading partner which presents the lowest price is selected among them. Generally, in case of auction-style acquiring systems, prices cannot be changed after the bidding has been completed.

For commodities, such as cataloged ones, qualities of which are steady and delivery times of which are short enough for the requirements, there is little possibility of changes in prices caused by design changes. On the other hand, for commodities specifications of which are given at the time of the bidding and which requires development to be performed after the bidding, there arises a case in which the bidding price presented by the trading partner must be changed because of such a reason that the buyer company has changed the specifications after the time of the bidding. In such cases, the buyer company must have further negotiation with the trading partner in order to change the price. Otherwise, in some cases, the buyer company must go back to bidding.

Further, the buyer company can recognize what extent of design changes is acceptable and can improve efficiency in design changes if the company is able to previously estimate changes in prices due to the design changes.

### DISCLOSURE OF INVENTION

The objective of the invention is to provide an automatic price correcting system which automatically calculates a price of an article, which has changed because of changes in the specifications of the article.

According to one aspect of the invention, an automatic price correcting system in which the seller and the buyer communicates with each other via network, is provided. The system comprises a standard price storing section, a standard specifications table and a correction table. The standard price storing section stores a price presented by the seller in response to specifications of an article presented by the buyer, as a standard price. The standard specifications table stores specifications presented by the buyer. The correction table stores information required to correct the standard price of the article, presented by the seller. The automatic price correcting system further comprises a control device. The control device converts difference between the specifications of the article stored in the standard specifications table and changed specifications of the article, into a correction value of price, trough means of referring to the correction table, when the specifications of the article are changed. Then, the control device corrects the standard price stored in the standard price storing section using the correction value of price.

According to the invention, a price of the article with changed specifications is automatically calculated, trough means of referring to the correction table. Accordingly, the buyer can easily validate the changes in the specifications. Further, according to the invention, an adjustment on the price caused by the changes in the specification can be more easily carried out both by the seller and the buyer. Accordingly, efficiency in changes of the specification is improved.

According to one embodiment of the invention, difference between the specifications of the article stored in the standard specifications table and changed specifications of the article, is obtained for each item of the specifications. The difference of the specifications for each item of the specifications is converted into a correction value of price through means of referring to the correction table. Then, the standard price stored in the standard price storing section is corrected by a total of correction values, which is a sum of correction values of prices for respective items of the specifications. The correction table stores unit prices for unit of respective items of the specifications. Thus, prices of respective items for changed specifications can be calculated through means of referring to the correction table.

According to one embodiment of the invention, a specifications change inputting screen for inputting changes in the specifications is provide for the buyer. In response to changed specifications input through the specifications change inputting screen, a corrected standard price, that is, a price for the changed specifications, is presented to the buyer. Thus, the buyer can interactively estimate a price for the changed specifications.

According to one embodiment of the invention, contents of the correction table are displayed on the specifications change inputting screen. The buyer can estimate a price for the changed specifications, through means of referring to the correction table. According to another embodiment of the invention, the correction table is associated with the specifications change inputting screen. For respective items of the specifications displayed on the specifications change inputting screen, the buyer can refer to the correction table corresponding to the items of the specifications. For example, when one of the items of the specifications displayed on the specifications change inputting screen, is selected, a correction table corresponding to the selected item is displayed. The buyer can validate the changes in the specifications while referring to the correction table.

### BRIEF DESCRIPTION OF DRAWINGS

FIG. 1 is a block diagram showing an overview of an automatic price correcting system connected to networks, according to one embodiment of the invention;

FIG. 2 is a block diagram showing an overview of a bidding system and an automatic correcting system, according to one embodiment of the invention;

FIG. 3 shows examples of data in (a) a standard specifications table, (b) a changed specifications table and (c) a correction table, according to one embodiment of the invention;

FIG. 4 illustrates a method for correcting a price, according to one embodiment of the invention;

FIG. 5 is a flowchart of a method for correcting a price, according to one embodiment of the invention;

FIG. 6 shows an example of a user screen for changing specifications, according to one embodiment of the invention;

FIG. 7 shows a screen displaying a corrected price after specifications have been changed through the screen of FIG. 6, according to the embodiment of the invention;

FIG. 8 shows another example of a user screen for changing specifications, according to another embodiment of the invention; and

FIG. 9 shows a screen displaying a corrected price after specifications have been changed through the screen of FIG. 8, according to the embodiment of the invention.

### BEST MODE FOR CARRYING OUT THE INVENTION

The automatic price correcting system, according to the present invention, is advantageously applied to bidding systems in which buyer companies present specifications of required articles and seller companies present their bidding prices responding to the presented specifications. However, the automatic price correcting system, according to the present invention, can be applied to various applications in which specifications may be changed independently of bidding systems.

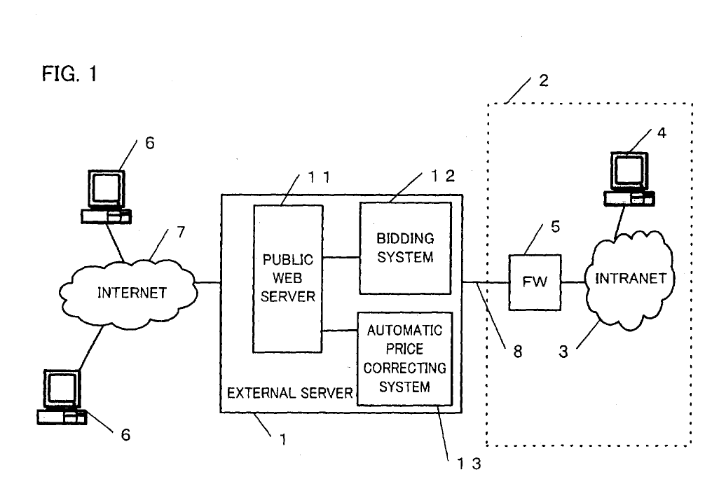

With reference to drawings, embodiments of the present invention in which the automatic price correcting system is applied to bidding systems utilizing networks, will be described. FIG. 1 is a general view of the automatic price correcting system (hereinafter referred to as the automatic correcting system) connected to networks, according to the present invention.

A company (buyer) 2 is provided with an intranet 3, which is an intra-company network, to which users 4 in the company are connected. The intranet 3 is connected to an external server 1 provided outside the company 2, via a firewall (FW) 5 and a private line 8. The firewall 5 checks electronic data running through the private line 8 and operates to ensure security of the company 2. Trading partners (sellers) 6 are connected to the Internet and able to access the external server 1 through the Internet. Thus, the company and any of the trading partners can communicate with each other via the external server 1.

The external server is provided with a public web server 11, a bidding system 12 and an automatic price correcting system 13. The public web server 11 is connected to the Internet 7 to make the web site of the company 2 open to the public. In the above way, general Internet users can access the web site of the company 2.

Thus, it is preferable to provide the public web server 11, the bidding system 12 and the automatic correcting system 13 in the external server 1 to prevent data in the company 2 from being accessed from the outside. However, the bidding system 12 and the automatic correcting system 13 may be provided inside the company 2.

The web site of the company 2 is provided with a bidding site. By entering the site, a trading partner can view matters to be quoted, which have been presented by the company 2, and can perform bidding for the matters. Generally, the trading partners 6 can enter the bidding site by inputting a user's ID and a password issued for the trading partner's exclusive use on a predetermined screen of the web site of the company 2. After the entering into the bidding site, communication between the trading partner 6 and the public web server 11 is carried out using encryption such as SSL to ensure security of the communication data.

The bidding system 12 selects the most appropriate trading partner for the matter among the trading partners who have taken part in the bidding, based on bidding information sent from the trading partners 6 via the Internet 7 and the public web server 11. The automatic price correcting system 13 automatically corrects the price according to subsequent changes in specifications of the matter subjected to the bidding, based on correction data sent by the trading partners 6 via the Internet 7 and the public web server 11.

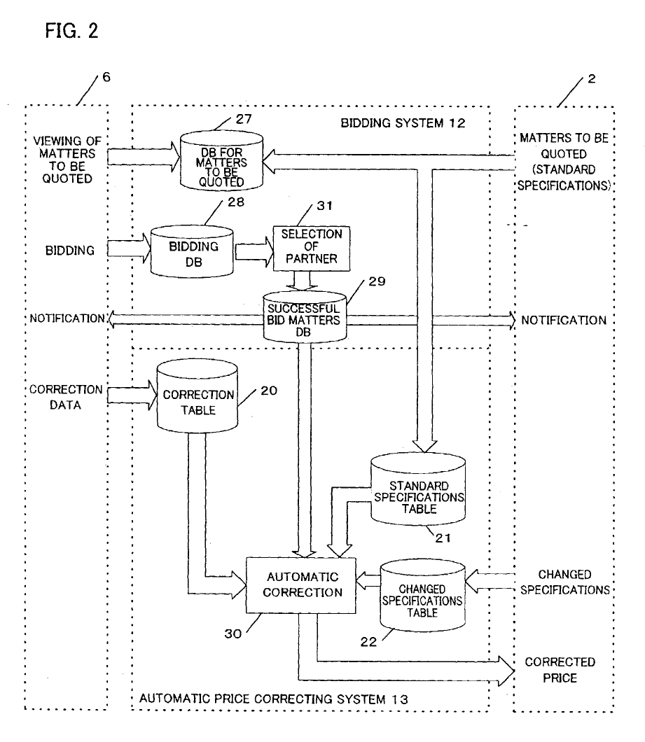

FIG. 2 is a functional block diagram of the bidding system 12 and the automatic price correcting system 13. The bidding system 12 is provided with a database 27 for matters to be quoted, a database 28 for bidding data and a database 29 for successful bid matters. (hereinafter, databases are abbreviated as DB.)

The DB 27 for matters to be quoted temporarily stores matters to be quoted, uploaded by the company 2. The matters to be quoted, includes standard drawings and standard specifications designed by the company 2. The bidding DB 28 temporarily stores bidding information input at bidding sites by trading partners 6. The bidding information includes a bidding price. The DB 29 for successful bid matters sores successful bid matters selected by a trading partner selecting section 31.

The automatic price correcting system 13 is provided with a standard specifications table 21, a changed specifications table 22 and a correction table 20. The standard specifications table 21 stores standard specifications uploaded via the intranet 3 by the company 2. As mentioned above, the standard specifications are included in the matters to be quoted, which are made open to the trading partners 6 by the company 2. Accordingly, the standard specifications can be stored in the standard specifications table 21 when the matters to be quoted are uploaded to the DB 27 for matters to be quoted.

The changed specifications table 22 stores changed specifications in case that there arise changes in the standard specifications. Changes in specification arise, for example, when the company 2 changes the standard drawings. When the company 2 changes specifications, it uploads the changed specifications into the changed specifications table 22.

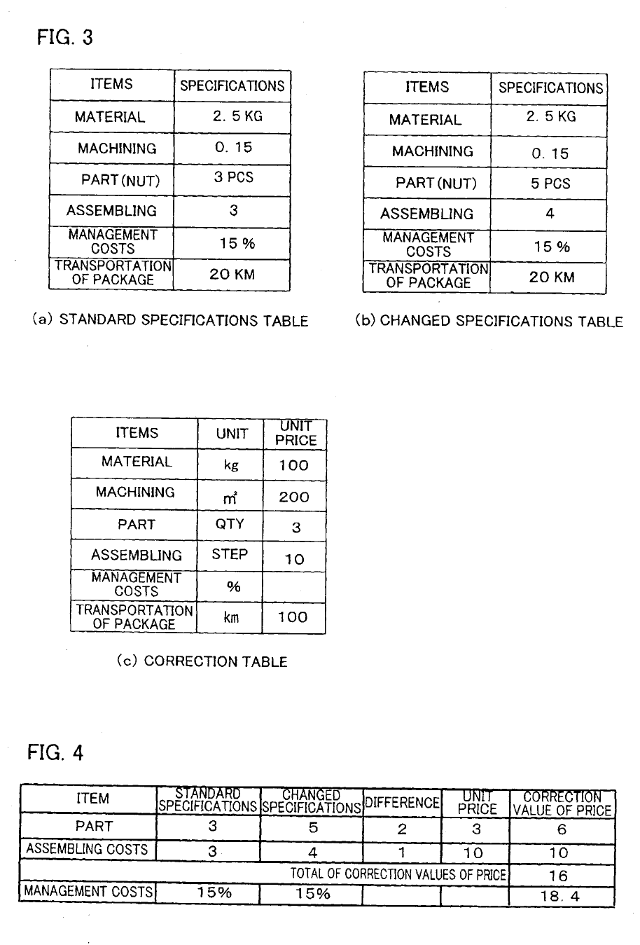

FIG. 3(a) and FIG. 3(b) respectively show examples of data in the standard specifications table 21 and changed specifications table 22. The standard specifications table 21 and changed specifications table 22 have data for each of matters to be subjected to bidding. As apparent from FIG. 3(a) and FIG. 3(b), specifications of the matters to be subjected to bidding have material, machining, part, assembling, management cost and transportation of package as items of the specifications and for each item of the specifications a required quantity is shown.

The correction table 20 stores correction data for the standard specifications at the time of the bidding. The correction data have been input and sent by trading partners 6, using a predetermined site (which may be the same with that for bidding). The correction data include data necessary to correct the bidding price when changes in the specifications for the matter subjected to the bidding arise. For example, the correction data include unit prices of material and part, machining rate of machining, a unit price of a man-hour for assembling and management costs. Further, a price table of optional parts for the matter subjected to the bidding can be included thereto.

FIG. 3(c) shows an example of data of the correction table 20 corresponding the standard specifications of FIG. 3(a). The correction table 20 stores a unit price for each unit of the above items. For example, in item “part” 3 yen is stored as unit price for unit QTY, as correction data. This shows that it costs 3 yen for each part.

Referring back to FIG. 2, outline of operation of the bidding system 12 and the automatic price correcting system 13, will be described. The company 2 designs an article by creating its standard drawings and prepares a matter to be quoted based on the standard drawings. The matter to be quoted includes the standard specifications corresponding to the standard drawings. The company 2 uploads the matters to be quoted into the DB 27 for matters to be quoted.

The public web server 11 (FIG. 1) publishes contents of the DB 27 for matters to be quoted, at the bidding site. Thus, each of the trading partners 6 can view the matters to be quoted by entering the bidding site. The company 2 may automatically send predetermined trading partners an e-mail informing that an matter to be quoted is to be published at the site at the same instant when the matter to be quoted is uploaded.

Standard specifications included in the matter to be quoted are stored in the standard specifications table 21 when the matter to be quoted is uploaded into the DB 27 for matters to be quoted. Alternately, standard specifications may be stored in the standard specifications table 21 after a trading partner is selected through bidding.

Trading partners 6 enter the bidding site and view the matter to be quoted to determine whether or not they take part in the bidding. When they wish to take part in the bidding, they input bidding information at the bidding site and send them. The bidding information thus sent is stored in the bidding DB 28.

Further, trading partners 6 input correction data corresponding to standard specifications of the matter to be quoted at a predetermined site and send them. The correction data thus sent are stored in the correction table 20. Sending of correction data from trading partners 6 should preferably be performed concurrently with or prior to bidding. Thus, the company 2 can take the correction data into consideration when selecting a trading partner for the matter to be quoted. In order to increase an accuracy of the correction table, trading partners should preferably be able to send latest correction data at any time.

Thus, the trading partner selecting section 31 selects a trading partner for the matter to be quoted, based on bidding information stored in the bidding DB 28. A trading partner may be selected in consideration of other information such as that of estimation on trading partners, input by the company 2. Further, as mentioned above, the correction table may be referred to for selecting a trading partner. The trading partner selecting section 31 selects a trading partner, then stores the successful bid matter of the trading partner in the successful bid matters DB 29 and sends the results of the bidding both to the trading partners 6 and the company 2. It can send them, for example, in the form of e-mail.

Now it is assumed that development has started after the bidding and the standard specifications of the article subjected to the bidding has been changed. The company 2 stores the changed specifications in the changed specifications table 22 via the intranet. An automatic correcting section 30 compares each item of the specifications in the standard specifications table 21 to that in the changed specifications table 22 to extract therefrom difference of each item of the specifications. Then, the automatic correcting section 30 converts the extracted differences of the specifications, into correction values of prices, by referring to the correction table 20. The automatic correcting section 30 extracts the bidding price from the successful bid matters DB 29 and corrects the bidding price with the correction values of prices. The price thus corrected is hereafter referred to as corrected price. The corrected price thus calculated is sent to the company 2.

In another embodiment, an in-house user 4 can estimate a corrected price interactively on-line. In this case, the changed specifications table 22 may be implemented by a working memory of the automatic correcting section 30. The automatic correcting section 30 temporarily stores changed specifications the user 4 has input from the screen, in the working memory. Then the automatic correcting section 30 converts difference between the changed specifications and the standard ones into correction values of prices to calculate a corrected price, as mentioned above.

Thus, the company 2 can easily estimate a change in price due to a design change. The company 2 can flexibly and quickly realizes a design change with a reasonable price.

Functional blocks for the automatic correcting section 30 and the trading partner selecting section 31, shown in FIG. 2, are typically implemented by computer programs stored in any memory device such as a magnetic disk, an optical disk and a nonvolatile memory. Alternately, they can be implemented by any kind of hardware arranged to carry out functions of the functional blocks. Each of the databases and tables shown in FIG. 2 can be provided in any memory device such as a magnetic disk, an optical disk and a nonvolatile memory. The tables may be defined directly in programs.

Now, the price correcting process executed by the automatic correcting section 30 is more specifically explained. FIG. 4 shows correction values of prices for the specifications changed as shown in FIGS. 3(a) and (b). In the standard specifications at the time of the bidding, number of the parts is 3 and number of the assembling steps is 3. On the other hand, in the changed specifications after development, the number of the parts and that of the assembling steps are changed respectively to 5 and 4. The difference in the specifications of the parts and assembling steps can be obtained by subtraction of number in the standard specifications from that in the changed specifications for each item. Accordingly, the difference in the specifications of the parts is “2”, while the difference in the specifications of the assembling steps is “1”. According to the correcting table 20, unit prices for unit part and unit assembling step are respectively 3 yen and 10 yen.

The automatic correcting section 30 calculates a correction value of price for each item of the specifications based on the following equation.

Correction value of price×unit price ×difference in the specifications

In the example of FIG. 3, difference “2” in the specifications of the parts is multiplied by unit price “3” of the parts to obtain a correction value “6” of price of the parts. On the other hand, difference “1” in the specifications of the assembling steps is multiplied by unit price “10” of the assembling steps to obtain a correction value “10” of price of the assembling steps. As a result, a total of correction values of prices is obtained as below.

10+6=16 yen

Further, in this embodiment, since a certain percentage of management cost is added to each item (the percentage of management cost remains unchanged after the change in the specifications), a total of correction values of prices is obtained as below.

16×1.15=18.4 yen

This means that the change in the specifications results in additional cost of 18.4 yen. Provided that the bidding price is 2666.85 yen, for example, the total of correction values of 18.4 yen is added to the bidding price so that a corrected price amounts to 2685.24 yen.

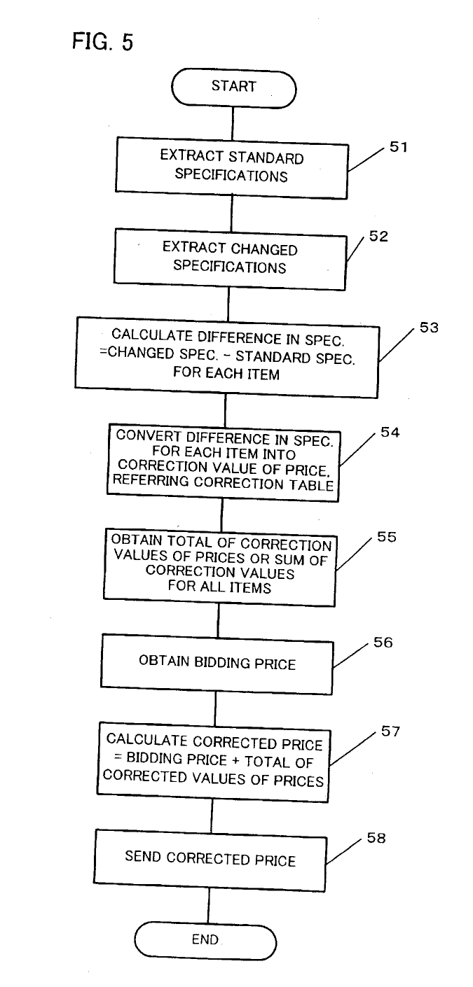

FIG. 5 is a flowchart showing the above-mentioned price correcting process executed by the automatic correcting section 30. In step 51, the standard specifications are extracted from the standard specifications table 21. In step 52, the changed specifications are extracted from the changed specifications table 22. As mentioned above, the changed specifications table 22 may be in a temporary storage allocated to programs implementing the automatic correcting section 30.

In step 53, difference between the changed specifications and the standard specifications is obtained for each item is obtained as explained above with reference to FIG. 4. In step 54, the difference of the specifications for each item, obtained in step 53, is converted into a correction value of price, through means of referring to the correction table 20. In step 55, the correction values of prices for all the items are added so that a total of correction values of prices is obtained.

In step 56, the bidding price is extracted form the successful bid matters DB 29. In step 57, the total of correction values of prices, obtained in step 55, is added to the extracted bidding price so that a corrected price is calculated. The corrected price thus calculated is sent to the company 2 in step 58.

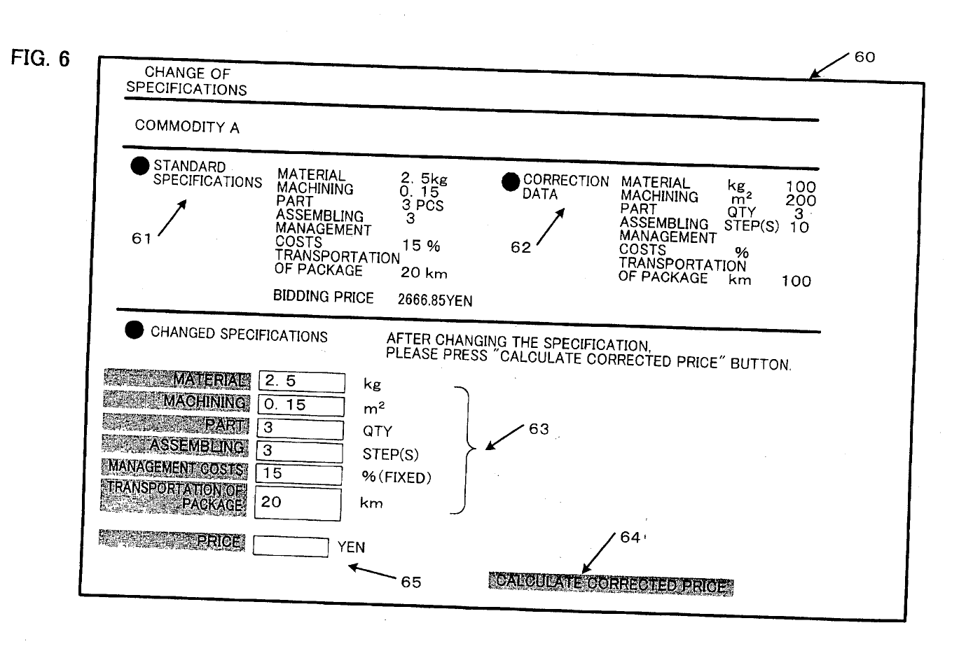

FIG. 6 is an example of a screen through which an in-house user 4 (FIG. 1) on-line estimates a corrected price after a change in the specifications. When a user inputs and sends, for example, a commodity code of “commodity A” through a predetermined screen, the automatic correcting section 30 is started. As explained with reference to step 51 of FIG. 5, the automatic correcting section 30 extracts the standard specifications 61 corresponding to the input commodity code from the standard specifications table 21 and further extracts correction data 62 corresponding to the standard specifications 61 to display the specifications and data on a screen 60.

The screen 60 is provided with fields 63 corresponding to respective items of the specifications, into which changed specifications are input. When the screen 60 is initially displayed, contents of the standard specifications 61 are displayed in respective fields. The user 4 can update values in the fields corresponding to items of the specifications to be changed, referring to the correction data 62.

After having updated items of the specifications, the user clicks on a “calculate corrected price” button 64 on the screen. In response to this, values input in respective fields are stored in the changed specifications table 22. The automatic correcting section 30 executes steps 52 to 57 in FIG. 5. That is, the automatic correcting section 30 extracts changed specifications from the changed specifications table 22 and calculates difference between the standard specifications and the changed specifications for each item of the specifications. Then, the automatic correcting section 30 converts the difference in the specifications into a correction value of price through means of referring to the correction table 20. It sums the correction values of prices for all the items to obtain a total of correction values of prices. Then, it adds the total of correction values to the bidding price to calculate a corrected price. The automatic correcting section 30 displays the corrected price thus calculated in a price field 65 on the screen.

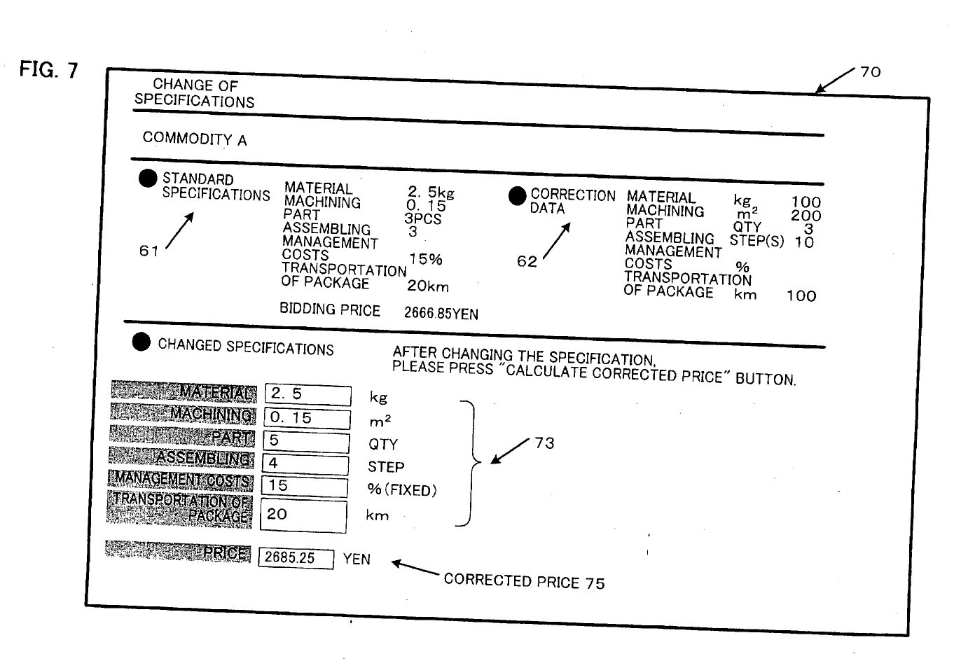

FIG. 7 shows the screen 70 displaying contents of the changed specifications 73 and the corrected price 75. As clearly shown in FIGS. 6 and 7, the user has updated a part field from “3” to “5” and an assembling field from “4” to “5” on the screen of FIG. 6 so that the bidding price of 2666.85 yen has been corrected to the corrected price of 2685.25 yen.

Thus, the user 4 can estimate a corrected price in real time. Accordingly, the user can flexibly and quickly proceed with a design change while referring to the correction data.

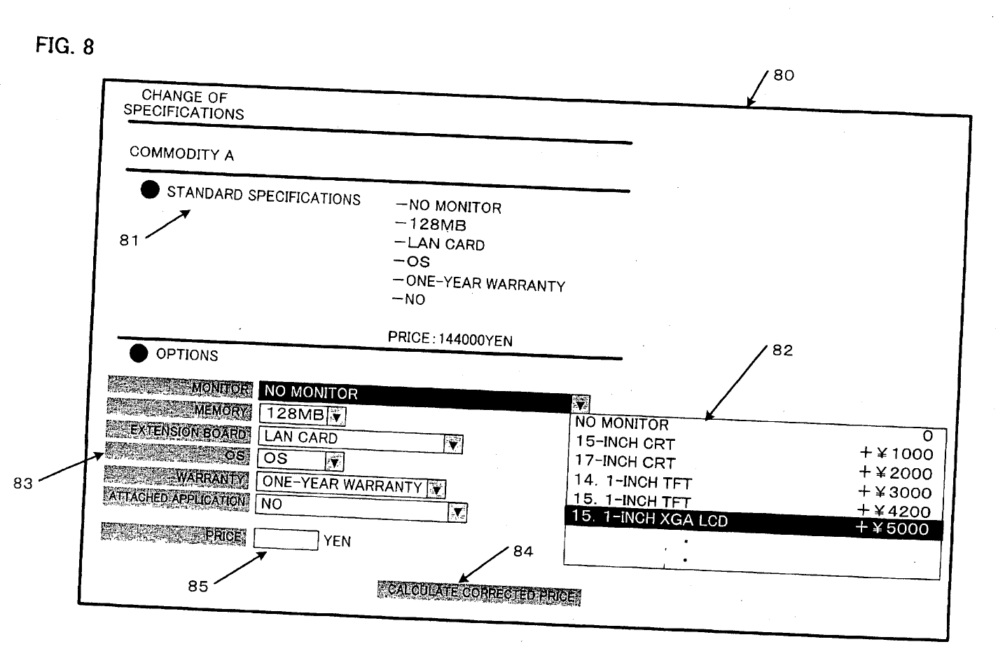

FIG. 8 shows an example of a screen through which the in-house user estimates a corrected price when on-line changing optional parts of the article subjected to the bidding. Changes of the specifications in FIG. 8 differ from changes of the specifications in FIG. 6 in that parts themselves that are provided as optional ones by the trading partner are changed. As in the case of FIG. 6, when a user inputs and sends, for example, a commodity code of “commodity A” through a predetermined screen, the automatic correcting section 30 is started. As explained with reference to step 51 of FIG. 5, the automatic correcting section 30 extracts the standard specifications 81 corresponding to the input commodity code from the standard specifications table 21 to display them on a screen 80. By this time, the automatic correcting section 30 may previously read correction data 82 corresponding to the standard specifications 81, from the correction table 20.

The screen 80 is provided with fields 83 for optional parts which can be selected. When the screen 80 is initially displayed, contents of the standard specifications 81 are displayed there. When an arrow on the right side of one of the optional parts fields is clicked on, the automatic correcting section 30 displays correction data 82 corresponding to the standard specifications. The user 4 can select a desired optional part from optional parts which can be selected.

FIG. 8 shows a state in which correction data 82 corresponding to “monitor” is displayed after the arrow on the right side of “monitor” field has been clicked on. As the correction data 82, not only types of monitors which can be selected but also correction values of prices for respective monitors to be selected, are displayed. The user 4, who selected “no monitor” at the time of the bidding, can study correction values of prices, which are to be caused by selection of monitors. For example, it can be seen that a change to “15-inch CRT” results in an increase of 1000 yen and a change to “15.1-inch XGA LCD” results in an increase of 5000 yen.

Thus, linking correction data 82 to the specification change screen 80 allows the user to carry out design changes in consideration of various combinations of options. Accordingly, efficiency of design changes is improved.

After having selected a desired option, the user clicks on a “calculate corrected price” button 84. In response to this, values input in respective fields 83 of options which can be selected, are stored as changed specifications in the changed specifications table 22.

The automatic correcting section 30 executes steps 52 to 57 in FIG. 5. That is, the automatic correcting section 30 extracts changed specifications from the changed specifications table 22 and calculates difference between the standard specifications and the changed specifications for each item of the specifications. Then, the automatic correcting section 30 converts the difference in the specifications into a correction value of price through means of referring to the correction table 20. It sums the correction values of prices for all the items to obtain a total of correction values of prices. Then, it adds the total of correction values to the bidding price to calculate a corrected price. The automatic correcting section 30 displays the corrected price thus calculated in a price field 85 on the screen.

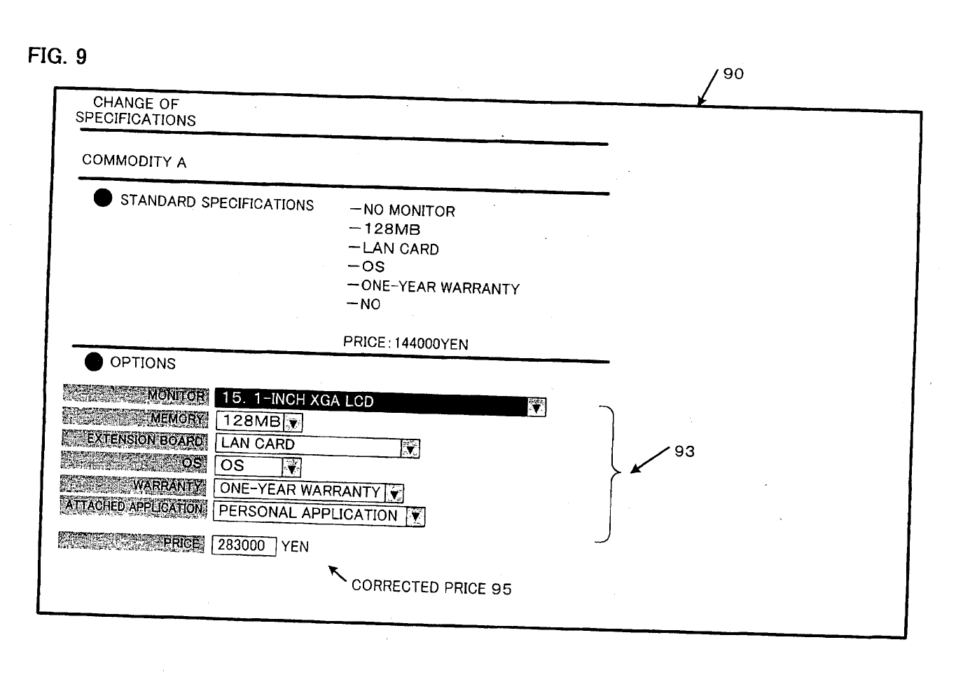

A screen 90 in FIG. 9 shows contents of the changed specifications 93 and the corrected price 95. As clearly shown in FIGS. 8 and 9, in this change of the specifications, “no monitor” is changed to “15.1-inch XGA LCD” for monitor and “no application” is changed to “personal application” for attached application so that the price is corrected from 144000 yen to 283000 yen.

Thus, the automatic price correcting system according to the invention can automatically correct the price corresponding to the standard specifications trough means of referring to the correction table presented by the trading partner, when some changes in the specifications arise in relation to the standard specifications.

In the embodiments mentioned above, the trading partner and the buyer company are connected via the Internet. The trading partner performs bidding through input means provided in a predetermined site by the buyer company and sends correction data through the Internet. Alternately, bidding may be performed and correction data may be sent through some other forms of networks besides the Internet. Further, the automatic price correcting system may be provided not outside the company but inside the company, or parts of the databases and programs comprised in the automatic price correcting system may be provided inside the company.

According to the invention, a price after a change of the specifications can be easily estimated through means of referring to the correction table. Accordingly, efficiency of validating changes in the specifications can be improved. Further, efficiency of renegotiation on price involved in changes in the specifications between the buyer company and the seller company, can be improved.

1. An automatic price correcting system in which the seller and the buyer communicate with each other via a network, comprising:
a standard price storing section for storing a price presented by the seller in response to specifications of an article presented by the buyer, as a standard price;
a standard specifications table for storing specifications presented by the buyer;
a correction table for storing information required to correct the standard price of the article, presented by the seller; and
a control device adapted to convert difference between the specifications of the article stored in the standard specifications table and changed specifications of the article, into a correction value of price, trough means of referring to the correction table, when the specifications of the article are changed and to correct the standard price stored in the standard price storing section using the correction value of price.

2. An automatic price correcting system according to claim 1, wherein the control device is adapted to obtain difference between the specifications of the article stored in the standard specifications table and changed specifications of the article, for each item of the specifications, to convert the difference of the specifications for each item of the specifications into a correction value of price through means of referring to the correction table and to correct the standard price stored in the standard price storing section by a total of correction values, which is a sum of correction values of prices for respective items of the specifications.

3. An automatic price correcting system according to claim 2, wherein the correction table stores unit prices for units of respective items of the specifications.

4. An automatic price correcting system according to claim 1, wherein the control device is adapted to provide for the buyer a specifications change inputting screen for inputting changes in the specifications, to calculate a corrected standard price in response to changed specifications input through the specifications change inputting screen, and to present the corrected standard price to the buyer.

5. An automatic price correcting system according to claim 4, wherein contents of the correction table are displayed on the specifications change inputting screen.

6. An automatic price correcting system according to claim 4, wherein the correction table is associated with the specifications change inputting screen so that for respective items of the specifications displayed on the specifications change inputting screen, the buyer can refer to the correction table corresponding to the items of the specifications.

7. A method for automatically correcting a price, comprising the steps of:
storing, in a standard price storing section, a price presented by the seller in response to specifications of an article presented by the buyer, as a standard price;
storing specifications presented by the buyer in a standard specifications table;
storing information required to correct the standard price of the article, presented by the seller in a correction table;
converting difference between the specifications of the article stored in the standard specifications table and changed specifications of the article, into a correction value of price, trough means of referring to the correction table when the specifications of the article are changed; and
correcting the standard price stored in the standard price storing section using the correction value of price.

8. A method for automatically correcting a price, according to claim 7, wherein the step of converting into a correction value of price further comprises the steps of:
obtaining difference between the specifications of the article stored in the standard specifications table and changed specifications of the article, for each item of the specifications;
converting the difference of the specifications for each item of the specifications into a correction value of price through means of referring to the correction table; and
correcting the standard price stored in the standard price storing section by a total of correction values, which is a sum of correction values of prices for respective items of the specifications.

9. A method for automatically correcting a price, according to claim 8, wherein the correction table stores unit prices for unit of respective items of the specifications.

10. A method for automatically correcting a price, according to claim 7, further comprising the steps of:
providing for the buyer a specifications change inputting screen for inputting changes in the specifications;
presenting the corrected standard price to the buyer in response to changed specifications input through the specifications change inputting screen.

11. A method for automatically correcting a price, according to claim 10, wherein contents of the correction table are displayed on the specifications change inputting screen.

12. A method for automatically correcting a price, according to claim 10, wherein the correction table is associated with the specifications change inputting screen so that for respective items of the specifications displayed on the specifications change inputting screen, the buyer can refer to the correction table corresponding to the items of the specifications.
